(19) United States
(12) Patent Application Publication
(10) Pub. No.: US 2026/0135277 A1
(43) Pub. Date: May 14, 2026

(54) SECONDARY BATTERY HAVING BENT STRIP TERMINAL AND METHOD AND APPARATUS FOR MANUFACTURING THE SAME

(71) Applicant: SAMSUNG SDI CO., LTD., Yongin-si (KR)

(72) Inventors: Donghyun KIM, Yongin-si (KR); Yejin SEO, Yongin-si (KR); Eunjeong MOON, Yongin-si (KR)

(21) Appl. No.: 19/259,096

(22) Filed: Jul. 3, 2025

(30) Foreign Application Priority Data
Nov. 13, 2024 (KR) 10-2024-0161354

(51) Int. Cl. H01M 50/566; B23K 20/10; H01M 10/04; H01M 50/103; H01M 50/105; H01M 50/557

(52) U.S. Cl. CPC H01M 50/566; B23K 20/106; H01M 10/0404; H01M 50/103; H01M 50/105; H01M 50/557

(57) ABSTRACT

A secondary battery includes an exterior material, an electrode assembly accommodated in the exterior material, the electrode assembly including a plurality of electrode plates having electrode tabs, and a strip terminal including a welding portion welded to the electrode tabs and a bending portion bent within the exterior material, wherein the strip terminal includes irregularities in at least the bending portion.

### CROSS-REFERENCE TO RELATED APPLICATION

This application claims priority to and the benefit of Korean Patent Application No. 10-2024-0161354, filed on Nov. 13, 2024, the disclosure of which is incorporated herein by reference in its entirety.

### BACKGROUND

### 1. Field

The present disclosure relates to a secondary battery having a bent strip terminal and a method and an apparatus for manufacturing the same.

### 2. Description of the Related Art

Unlike primary batteries that are not rechargeable, secondary batteries that can be charged and discharged. Low-capacity secondary batteries are used in portable small electronic devices such as smartphones, feature phones, laptop computers, digital cameras, and camcorders, whereas large-capacity secondary batteries are widely used as power sources for driving motors in hybrid vehicles, electric vehicles, and the like as well as for power storage batteries of hybrid vehicles, electric vehicles, and the like. A secondary battery includes an electrode assembly formed of a positive electrode and a negative electrode, an exterior material such as a case or can for accommodating the electrode assembly, external terminals electrically connected to the electrode assembly, and the like.

The above information disclosed in this Background section is for enhancement of understanding of the background of the present disclosure, and therefore, it may contain information that does not constitute a related (or prior) art.

### SUMMARY

Embodiments include a secondary battery, including an exterior material, an electrode assembly accommodated in the exterior material, the electrode assembly including a plurality of electrode plates having electrode tabs, and a strip terminal including a welding portion welded to the electrode tabs and a bending portion bent within the exterior material, wherein the strip terminal includes irregularities in at least the bending portion.

A bending angle of the bending portion of the strip terminal may be 90° or less.

The secondary battery may further include a tab film bonded to the strip terminal.

The exterior material may be an exterior pouch of a pouch-type secondary battery.

The exterior material may be an external can of a prismatic secondary battery.

Embodiments include a method of manufacturing a secondary battery, the method including providing an electrode assembly including a plurality of electrode plates, forming electrode tabs on the plurality of electrode plates, forming a welding portion by welding a strip terminal to the electrode tabs, forming irregularities in a bending portion of the strip terminal, resulting in formed irregularities, bending the bending portion having the formed irregularities, resulting in a bent strip terminal, bending the electrode tabs, resulting in bent electrode tabs, and accommodating the electrode assembly with the bent strip terminal and the bent electrode tabs into an exterior material of the secondary battery.

Forming the irregularities may include pressing at least one of an upper surface and a lower surface of the bending portion using an irregularity forming jig.

The irregularity forming jig may include a horn for ultrasonic welding.

Bending the bending portion with the formed irregularities may include bending the strip terminal at an angle of 90° or less.

Bending the bending portion with the formed irregularities may include supporting the strip terminal with a support jig, and bending the bending portion by pushing the strip terminal supported by the support jig toward a bending jig.

Bending the bending portion with the formed irregularities may further include supporting the electrode tabs using a front guide in a direction opposite to a direction in which the support jig supports the welding portion.

Bending the electrode tabs may include pushing the bent strip terminal toward the electrode assembly.

Accommodating the electrode assembly into the exterior material may include accommodating the electrode assembly in one of an external pouch of a pouch-type secondary battery and an external can of a prismatic secondary battery.

Embodiments include an apparatus for manufacturing a secondary battery, the apparatus including a welding unit configured to form a welding portion by welding a strip terminal to electrode tabs on a plurality of electrode plates included in an electrode assembly, an irregularity forming jig configured to form irregularities in a bending portion of the strip terminal, and a bending jig configured to bend the bending portion of the strip terminal where the irregularities are and to bend the electrode tabs.

The irregularity forming jig may include a horn for ultrasonic welding configured to form the irregularities by pressing at least one of an upper surface and a lower surface of the bending portion.

The bending jig may include a support jig configured to support the strip terminal, and a roller configured to bend the bending portion of the strip terminal by pushing the strip terminal supported by the support jig, resulting in a bent strip terminal.

The support jig of the bending jig may push the bent strip terminal toward the electrode assembly to bend the electrode tabs.

The support jig of the bending jig may include a support surface of 90° or less so that the roller presses the strip terminal to form the bending portion at a bending angle of 90° or less.

The bending jig may further include a front guide configured to support the electrode tabs in a direction opposite to a direction in which the support jig supports the strip terminal.

The front guide may be further configured to move away from the strip terminal when the support jig bends the electrode tabs.

### BRIEF DESCRIPTION OF THE DRAWINGS

Features will become apparent to those of ordinary skill in the art by describing in detail exemplary embodiments with reference to the attached drawings, in which:

FIG. 1 is a schematic diagram illustrating an electrode assembly of a secondary battery;

FIG. 2 is a schematic diagram illustrating a pouch-type secondary battery to which the electrode assembly manufactured according to the present disclosure is applicable;

FIG. 3 is a cross-sectional view illustrating the inside of the electrode assembly accommodated in a pouch in the pouch-type secondary battery of FIG. 2;

FIG. 4A is a diagram illustrating a bending structure of a strip terminal of the secondary battery according to some embodiments of the present disclosure;

FIG. 4B is a diagram illustrating a bending structure of a strip terminal of the secondary battery according to some other embodiments of the present disclosure;

FIGS. 5A to 5G are diagrams for describing a method of bending a strip terminal according to some embodiments;

FIG. 6 is a diagram illustrating a strip terminal bending jig and a support jig according to some other embodiments of the present disclosure; and

FIG. 7 is a schematic diagram illustrating a prismatic secondary battery to which the electrode assembly manufactured according to the present disclosure is applicable.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be

### “interposed” Between the Components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

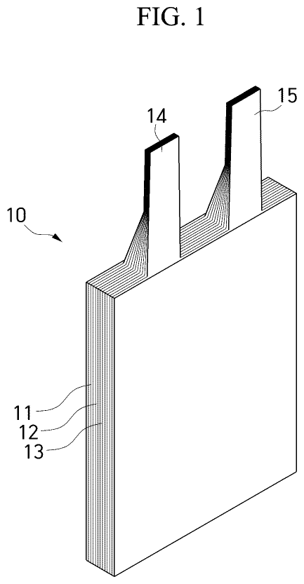

FIG. 1 is a schematic diagram illustrating an example of an electrode assembly of a secondary battery.

An electrode assembly 10 may be formed by stacking a stack of a first electrode plate 11, a separator 12, and a second electrode plate 13, each of which are formed as thin plates or films. The electrode assembly 10 shown in FIG. 1 is a stacked type, but the shape of the electrode assembly 10 may be a wound type, or the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case may vary. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 of each first electrode plate 11 may all be welded to one another and be connected to an external first terminal.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. Also, the second electrode tab 15 of each electrode plate may be welded and be connected to an external second terminal.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

In some embodiments, the electrode assembly 10 may be accommodated in a case along with an electrolyte. In a pouch-type secondary battery, an electrode assembly 10 may be accommodated in a pouch made of flexible material. In a cylindrical or prismatic secondary battery, an electrode assembly 10 may be accommodated in a cylindrical or prismatic metal casing.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but the substrate material may vary.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x≤2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof.

The organic material and the inorganic material may be mixed in one coating layer or may be in the form of a coating layer including (or containing) an organic material and a coating layer including (or containing) an inorganic material that are stacked on each other.

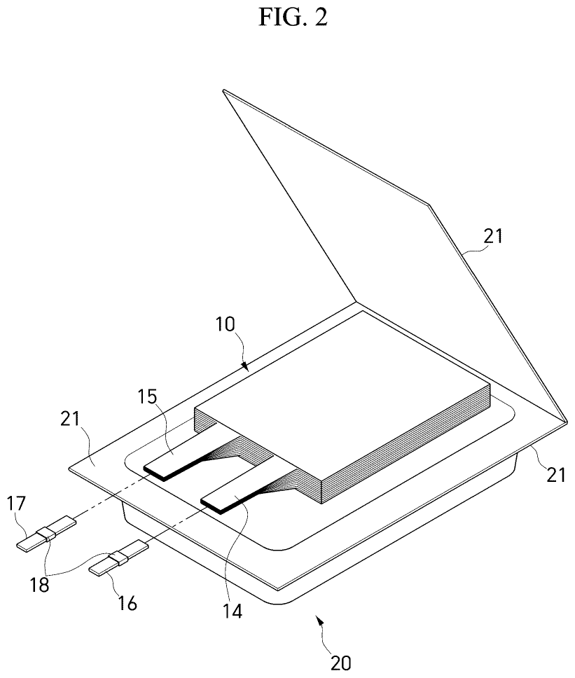

FIG. 2 schematically shows a pouch-type secondary battery according to some embodiments of the present disclosure.

The pouch-type secondary battery according to the present embodiment may include an electrode assembly 10 and a pouch 20 for accommodating the electrode assembly 10.

As shown in FIG. 2, first electrode tabs 14 and second electrode tabs 15 of the electrode assembly 10 may be bonded and electrically connected to a first strip terminal 16 and a second strip terminal 17, respectively, which serve as terminals exposed to the outside. Tab films 18 for insulation with the pouch 20 may be bonded to the first strip terminal 16 and the second strip terminal 17.

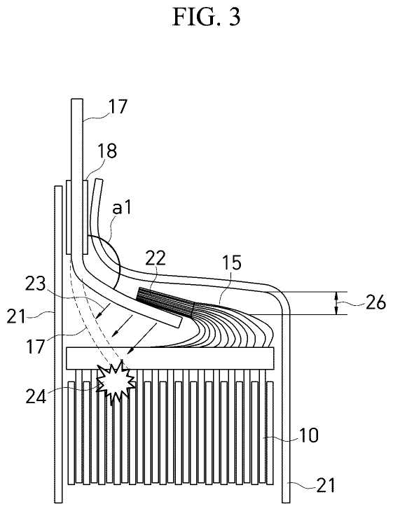

FIG. 3 is a cross-sectional view illustrating a state in which the electrode tab 15 and the strip terminal 17 of the electrode assembly 10 are bonded to each other in the pouch-type battery and accommodated inside an exterior material 21 that is the pouch 20.

As shown in the drawings, the electrode assembly 10 is accommodated inside the pouch 20, and the second electrode tabs 15 formed on electrode plates constituting the electrode assembly 10 are gathered and welded to the strip terminal 17 to form a welding portion 22. The tab film 18 bonded to the strip terminal 17 may be sealed at an outer boundary of the pouch 20, and a portion of the strip terminal 17 may be exposed to the outside.

The second electrode tabs 15 and the strip terminal 17 are bent as shown in FIG. 3 and accommodated inside the pouch 20. Generally, as shown in FIG. 3, a bent portion of the strip terminal 17 has a bending angle a1 of an obtuse angle that is greater than 90°. This is because, especially in the case of the electrode assembly 10 being stacked, as shown in FIG. 1, since the plurality of second electrode tabs 15 are stacked and then welded to the strip terminal 17, there is a technical limitation that it is difficult to achieve bending at a right angle or an acute angle smaller than a right angle due to rigidities of the strip terminal 17 and the second electrode tabs 15 that are stacked.

In this way, a tensile force is always applied to the strip terminal 17 bent at an obtuse angle in a direction of arrows 23. Therefore, the welding portion 22 with the second electrode tabs 15 may be destroyed, and the strip terminal 17 that is separated may damage the electrode plates and cause a short-circuit 24 between the electrode plates. In addition to this safety problem, due to the bending of the strip terminal 17 at the obtuse angle, there is also a problem that related members occupy a larger portion of an upper inner space 26 of the pouch 20, reducing space utilization within the battery. These problems may be exacerbated as the number of electrode plates in the electrode assembly 10 (stacked) increases with an increase in battery energy capacity.

In order to solve these problems, a bending method is proposed to easily make a bent angle of the strip terminal 17 an acute angle that is less than or equal to a right angle of 90° using a relatively simplified process and equipment.

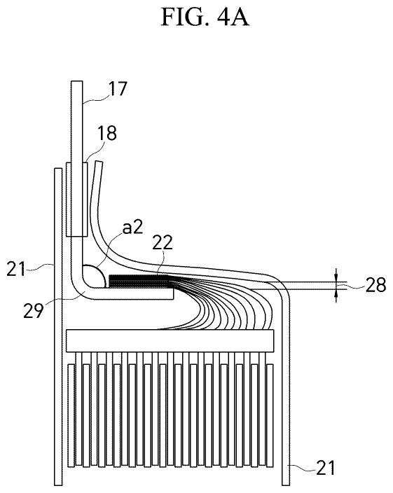

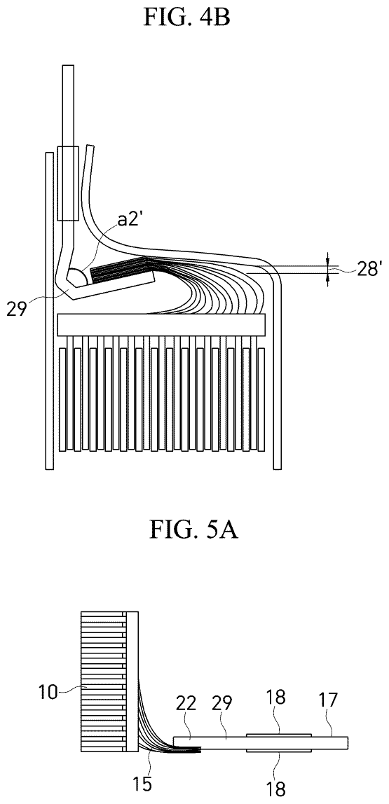

FIG. 4A is a diagram illustrating a bending structure of a strip terminal of the secondary battery shown in FIG. 2.

As shown in the drawing, the electrode assembly 10 is accommodated inside the pouch 20, and the second electrode tabs 15 (see FIG. 3) formed on the electrode plates of the electrode assembly 10 are gathered and welded to the strip terminal 17 to form the welding portion 22. The tab film 18 bonded to the strip terminal 17 may perform a sealing function at the outer boundary of the pouch 20 and also perform an insulating function between an exterior material 21 that is the pouch 20 and the strip terminal 17. A portion of the strip terminal 17 is exposed to the outside.

The second electrode tabs 15 and the strip terminal 17 are bent and accommodated inside the pouch 20. A bending portion 29 of the strip terminal 17 has a bending angle a2 of about 90°. Thus, a separation force applied to the welding portion 22 (see the description of reference numeral 23 in FIG. 3) is reduced so that the welding portion 22 may remain stable. In addition, since the strip terminal 17 is bent more compactly than in the case of FIG. 3, an upper space 28 of the pouch 20 is reduced so that the space utilization of the battery can be increased and energy density compared to the same pouch size can be improved.

FIG. 4B is a diagram illustrating a bending structure of a strip terminal of the secondary battery according to some other embodiments of the present disclosure. In these embodiments, the bending portion 29 of the strip terminal 17 is bent more compactly than in the case of FIG. 4A to have an acute angle a2′ that is smaller than 90°. Thus, a separation force applied to the welding portion 22 may be further reduced than in the embodiment of FIG. 4A. Even in these embodiments, an upper space 28′ of the pouch 20 is further reduced than in the case of FIG. 3 so that the space utilization of the battery can be increased.

In the embodiments of FIGS. 4A and 4B, the bending portion 29 of the strip terminal 17 may include a portion excluding the welding portion 22. However, for example, the welding portion 22 may be included in the bending portion 29 of the strip terminal 17 so that, when the strip terminal 17 is bent, the welding portion 22 may also be bent.

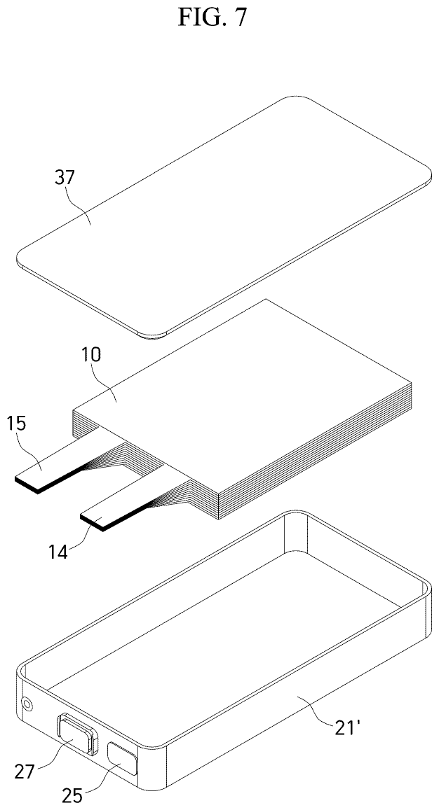

In addition, although the embodiments of FIGS. 4A and 4B relate to the bending structure of the strip terminal applied to an external pouch of a pouch-type secondary battery, according to some other embodiments, the bending structure of the strip terminal may also be applied to an external can of a prismatic secondary battery (see FIG. 7).

In this way, it is desirable for the bending portion 29 of the strip terminal to be bent at an angle of 90° or less, but it is not technically easy to bend the bending portion 29 at an angle of 90° or less due to rigidity of the electrode tabs and the strip terminal of the stacked electrode assembly. In order to overcome this limitation, a method of softening the bending portion 29 of the strip terminal, i.e., a region to be bent, and then performing bending is proposed. In order to soften the bending portion 29, one or more irregularities may be formed in a corresponding region (e.g., holes, indentations, etc. made in the strip terminal to make the bending portion more pliable). In some embodiments, the irregularities may be formed by pressing at least one of upper and lower surfaces of the bending portion 29 using an irregularity forming jig. By forming the irregularities in the bending portion 29, properties of the strip terminal in the corresponding region may be elongated and softened.

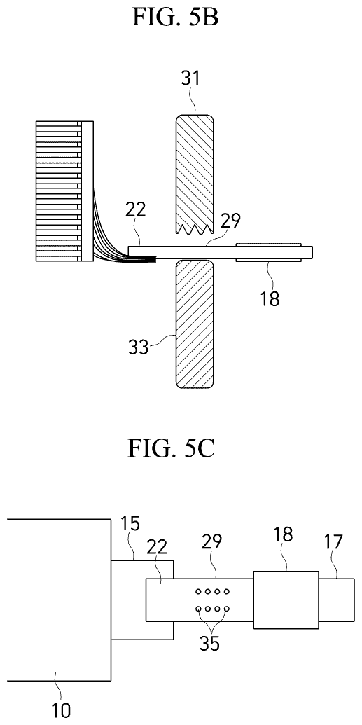

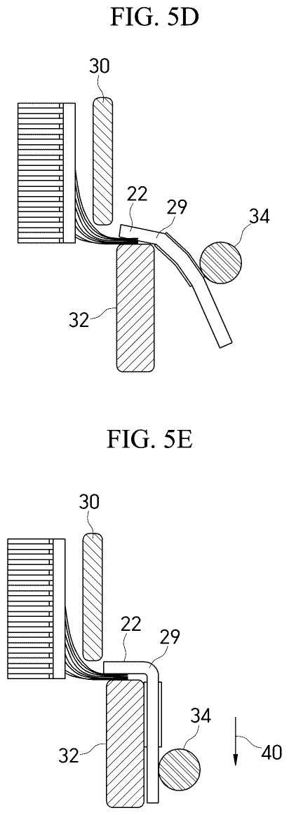

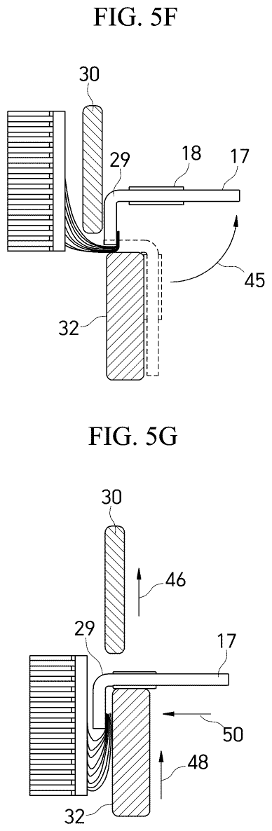

Hereinafter, a method of manufacturing a secondary battery according to some embodiments of the present disclosure will be described. The following method description will be mainly based on the process of bending the strip terminal as described above. FIGS. 5A to 5G are diagrams for describing a method of bending a strip terminal according to some embodiments.

The method of manufacturing a secondary battery according to some embodiments of the present disclosure may include providing an electrode assembly including a plurality of electrode plates on which electrode tabs are formed, forming a welding portion by welding a strip terminal to the electrode tabs formed on the plurality of electrode plates of the electrode assembly, forming irregularities in the bending portion of the strip terminal, bending the bending portion in which the irregularities are formed, bending the electrode tabs, and accommodating the electrode assembly with the strip terminal and the bent strip terminal into an exterior material. Each of the operations will be described in detail.

The electrode assembly provided in the providing of the electrode assembly may be the electrode assembly 10 (stacked) shown in FIG. 1, but a wounded-type electrode assembly is also possible. In order to provide the electrode assembly, for example, as described above, a substrate is coated with a positive electrode material and another substrate is coated with a negative electrode material, and the electrode tabs are formed using a notching unit to manufacture a positive electrode plate and a negative electrode plate. In addition, these electrode plates and a separator may be stacked or wound to manufacture the electrode assembly.

The forming of the welding portion by welding the strip terminal to the electrode tabs of the electrode assembly may be performed using a welding unit. As shown in FIG. 4A or 4B, the welding unit may bond the plurality of second electrode tabs 15 by welding the strip terminal 17 to the welded electrode tabs to form the welding portion 22. The welding unit may include ultrasonic welding equipment or laser welding equipment, but other types of welding equipment are possible.

In an operation before the bending of the strip terminal 17, the strip terminal 17 may be placed horizontally on a workbench as shown in FIG. 5A. FIG. 5A shows the welding portion 22 in which the second electrode tabs 15 formed on the electrode plates constituting the electrode assembly 10 and one end of the strip terminal 17 are welded and the bending portion 29 adjacent to the second electrode tabs 15. The above-described tab film 18 may also be bonded to the strip terminal 17.

In bending the strip terminal 17 placed as shown in FIG. 5A at an angle of 90° or less as shown in FIG. 4A or 4B, as described above, the bending portion 29 of the strip terminal 17 may be a portion excluding the welding portion 22. However, since at least a portion of the welding portion 22 is included in the bending portion 29 of the strip terminal 17, when the strip terminal 17 is bent, the welding portion 22 may also be bent together with the strip terminal 17.

The forming of the irregularities in the bending portion of the strip terminal will be described with reference to FIGS. 5B and 5C.

The irregularities may be formed on at least one of upper and lower surfaces of the bending portion 29. According to some embodiments, as shown in FIG. 5B, the irregularities may be formed on the upper surface of the bending portion 29 of the strip terminal 17 by placing an irregularity forming jig 31 on the upper surface of strip terminal 17 and placing a support jig 33 on a lower surface of strip terminal 17. In this case, a downward pressure of the irregularity forming jig 31 placed on the upper surface may be adjusted so that the irregularities are formed from the upper surface to the lower surface of the bending portion 29. In another embodiment, the irregularity forming jig 31 may be placed on the lower surface of the bending portion 29 to form the irregularities on the lower surface of the bending portion 29. In still another embodiment, the irregularity forming jig 31 may be placed on the upper surface and the lower surface of the bending portion 29 to form the irregularities on the upper surface and the lower surface of the bending portion 29.

FIG. 5C is a plan view illustrating the appearance of the strip terminal 17 including the bending portion 29 on which the irregularities 35 are formed. As described above, by forming the irregularities 35 in the bending portion 29 of the strip terminal 17, the substrate in the corresponding area may be elongated and softened, and bending may be easier in a subsequent strip terminal bending process.

In some embodiments, the irregularity forming jig 31 in FIG. 5B may include a horn for ultrasonic welding (e.g., an ultrasonic welding horn). In this case, the support jig 33 may be an anvil for ultrasonic welding. In this case, a protrusion of the horn and/or anvil may be used to form the irregularities 35 without the need to apply ultrasonic waves, but applying ultrasonic waves may also help to soften the substrate of the strip terminal. In another embodiment, the irregularity forming jig 31 and/or the support jig 33 may include a press or hammer having protrusions for forming the irregularities.

Next, the bending of the strip terminal 17 may be performed as shown in FIGS. 5D and 5E.

First, as shown in FIG. 5D, a support jig 32 applies a rising force (e.g., upward in the orientation shown) to support substantially a lower portion of the welding portion 22 of the strip terminal 17, and a front guide 30 applies a downward force to support substantially upper portions of the second electrode tabs 15 in a direction opposite to a direction in which the support jig 32 supports the welding portion 22. A roller 34 is waiting above on the surface of the welding portion 22 of the strip terminal 17. Here, the support jig 32, the front guide 30, and the roller 34 are collectively referred to as a bending jig.

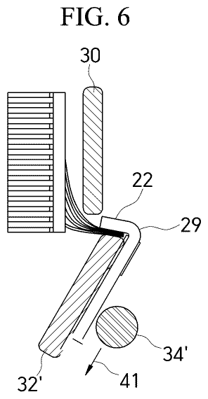

In this way, in a state in which the lower portion of the welding portion 22 is supported by the support jig 32 and the upper portions of the second electrode tabs 15 are supported by the front guide 30, as shown in FIGS. 5D and 5E, the roller 34 rolls down while pressing against the surface of the strip terminal 17. The bending portion 29 of the strip terminal 17 may be bent to match a shape of the support surface of the support jig 32 by a downward force 40 of the roller 34 (approximately 90° in the case of FIG. 5E). When the bending portion 29 of the strip terminal 17 is to be formed at an acute angle of 90° or less, the support jig 32 may be manufactured so that a support surface shape of the support jig 32 becomes 90° or less (see FIG. 6).

The bending of the electrode tabs may be performed as shown in FIGS. 5F and 5G. First, the roller 34 earlier used in FIG. 5E is moved away from the strip terminal 17, and the strip terminal 17 bent at an angle of approximately 90° is rotated vertically upward so that, as shown in FIG. 5F, the welding portion 22 of FIG. 5E is positioned to face the electrode assembly 10 and the tab film 18 is positioned horizontally. In some embodiments, a jig for a perpendicular rotation 45 of the strip terminal 17 may be used. Subsequently, as shown in FIG. 5G, the front guide 30 is moved upward as shown by an arrow 46 and moved away from a position supporting the second electrode tabs 15. Then, the support jig 32 is further moved upward as shown by an arrow 48 to raise the strip terminal 17 and is moved forward (to the left in the orientation shown) as shown by an arrow 50 toward the electrode assembly 10 to push the welding portion 22 and bend the second electrode tabs 15.

Finally, accommodating the electrode assembly 10 in which the strip terminal 17 and the second electrode tabs 15 are bent into the exterior material may be performed using a conventional exterior material accommodating method. For example, in the case of a pouch-type secondary battery, as shown in FIG. 3, the tab film 18 of the strip terminal 17 may be sealed at an upper boundary of the pouch 20, and a portion of the strip terminal 17 may be exposed to the outside. As another example, in the case of a prismatic secondary battery, the electrode assembly may be inserted into an outer can, such as an aluminum or stainless steel (SUS) can, and the strip terminal may be welded to an external terminal (see FIG. 7).

FIG. 6 shows another embodiment of a strip terminal support jig.

In order to bend the bending portion 29 at an acute angle less than 90°, for example, 60°, a support jig 32′ in which a support surface supporting the strip terminal 17 is formed at an acute angle of 90° or less is shown in FIG. 6. As the roller 34′ rolls along the support surface in a direction 41, an angle of the bending portion 29 of the strip terminal 17 may become less than 90°, for example, 60°. In this way, it is possible to provide a secondary battery that exhibits the same effect as described in FIG. 4B.

An apparatus for manufacturing a secondary battery according to some embodiments of the present disclosure will be described. The following manufacturing apparatus description will be mainly based on equipment used in the process of bending the strip terminal as described above.

The apparatus for manufacturing a secondary battery according to some embodiments of the present disclosure includes a welding unit configured to form the welding portion 22 by welding the strip terminal 17 to the second electrode tabs 15 formed on the plurality of electrode plates included in the electrode assembly 10, an irregularity forming jig 31 configured to form the irregularities 35 on the bending portion 29 of the strip terminal 17, and a bending jig configured to bend the bending portion 29 of the strip terminal 17 on which the irregularities 35 are formed and bend the second electrode tabs 15.

The welding unit may be equipment for bonding the plurality of second electrode tabs 15 by welding and for welding the strip terminal 17 to the welded second electrode tabs 15 to form the welding portion 22. The welding unit may include ultrasonic welding equipment or laser welding equipment, but other types of welding equipment may be used.

The irregularity forming jig 31 may include a horn for ultrasonic welding that presses at least one of the upper and lower surfaces of the bending portion 29 to form the irregularities 35, but may vary.

The bending jig may include the support jig 32 configured to support the strip terminal 17, and the roller 34 configured to push the strip terminal 17 supported on the support jig 32 to bend the bending portion 29 of the strip terminal 17.

In some embodiments, the support jig 32 may be formed to support a lower portion of the welding portion 22 of the strip terminal 17.

In some embodiments, the support jig 32 may be further formed to bend the second electrode tabs 15 by pushing the strip terminal 17 that is bent by the roller 34 toward the electrode assembly 10.

In some embodiments, the bending jig may further include the front guide 30 configured to support the second electrode tabs 15 in a direction opposite to a direction in which the support jig 32 supports the strip terminal 17.

In some embodiments, a mechanism may be required to move the front guide 30 away from the strip terminal 17 when the support jig 32 bends the second electrode tabs 15.

The secondary battery and the apparatus and method for manufacturing the same according to the above-described embodiments of the present disclosure may be applied to types of secondary batteries other than the pouch-type batteries exemplified above (e.g., prismatic secondary batteries).

As an example, a prismatic secondary battery shown in FIG. 7 has a structure in which a wide lateral surface of a can 21′ that is an exterior material of a battery is open, the electrode assembly 10 is inserted into the opening, and a cover 37 covers the opening. A first strip terminal and a second strip terminal electrically connected to a first terminal 27 and a second terminal 25, which are exposed to the outside of the can 21′, may be connected to the first electrode tabs 14 and the second electrode tabs 15 of the electrode assembly 10 inside the outer can 21′ by welding, and the first strip terminal and the second strip terminal may be bent by the bending method of the present disclosure described above.

An electrical connection between the electrode assembly and the external terminals may be made by welding electrode tabs formed on the electrode assembly to strip terminals. When the electrode assembly is assembled with the exterior material of the battery (a can or pouch), there are cases in which strip terminals are welded to the electrode tabs formed on electrode plates and then the strip terminals are bent. When a bent strip terminal is separated from a welding portion with the electrode tab, a safety problem of the battery may occur, and when a bending angle of the strip terminal is an obtuse angle, a problem of reduced space utilization due to occupying space inside the exterior material arises.

According to the present disclosure, when a strip terminal is bent, the strip terminal can be effectively and easily bent using a relatively simplified process and equipment, thereby obtaining effects of improved productivity and uniform performance of a secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an exterior material;
an electrode assembly accommodated in the exterior material, the electrode assembly comprising a plurality of electrode plates having electrode tabs; and
a strip terminal comprising a welding portion welded to the electrode tabs and a bending portion bent within the exterior material,
wherein the strip terminal includes irregularities in at least the bending portion.

2. The secondary battery as claimed in claim 1, wherein a bending angle of the bending portion of the strip terminal is 90° or less.

3. The secondary battery as claimed in claim 1, further comprising a tab film bonded to the strip terminal.

4. The secondary battery as claimed in claim 1, wherein the exterior material is an exterior pouch of a pouch-type secondary battery.

5. The secondary battery as claimed in claim 1, wherein the exterior material is an external can of a prismatic secondary battery.

6. A method of manufacturing a secondary battery, the method comprising:
providing an electrode assembly including a plurality of electrode plates;
forming electrode tabs on the plurality of electrode plates;
forming a welding portion by welding a strip terminal to the electrode tabs;
forming irregularities in a bending portion of the strip terminal, resulting in formed irregularities;
bending the bending portion having the formed irregularities, resulting in a bent strip terminal;
bending the electrode tabs, resulting in bent electrode tabs; and
accommodating the electrode assembly with the bent strip terminal and the bent electrode tabs into an exterior material of the secondary battery.

7. The method as claimed in claim 6, wherein forming the irregularities comprises pressing at least one of an upper surface and a lower surface of the bending portion using an irregularity forming jig.

8. The method as claimed in claim 7, wherein the irregularity forming jig comprises a horn for ultrasonic welding.

9. The method as claimed in claim 6, wherein bending the bending portion with the formed irregularities comprises bending the strip terminal at an angle of 90° or less.

10. The method as claimed in claim 6, wherein bending the bending portion with the formed irregularities comprises:
supporting the strip terminal with a support jig; and
bending the bending portion by pushing the strip terminal supported by the support jig toward a bending jig.

11. The method as claimed in claim 10, wherein bending the bending portion with the formed irregularities further comprises supporting the electrode tabs using a front guide in a direction opposite to a direction in which the support jig supports the welding portion.

12. The method as claimed in claim 6, wherein bending the electrode tabs comprises pushing the bent strip terminal toward the electrode assembly.

13. The method as claimed in claim 6, wherein accommodating the electrode assembly into the exterior material comprises accommodating the electrode assembly in one of an external pouch of a pouch-type secondary battery and an external can of a prismatic secondary battery.

14. An apparatus for manufacturing a secondary battery, the apparatus comprising:
a welding unit configured to form a welding portion by welding a strip terminal to electrode tabs on a plurality of electrode plates included in an electrode assembly;
an irregularity forming jig configured to form irregularities in a bending portion of the strip terminal; and
a bending jig configured to bend the bending portion of the strip terminal where the irregularities are and to bend the electrode tabs.

15. The apparatus as claimed in claim 14, wherein the irregularity forming jig comprises a horn for ultrasonic welding configured to form the irregularities by pressing at least one of an upper surface and a lower surface of the bending portion.

16. The apparatus as claimed in claim 14, wherein the bending jig comprises:
a support jig configured to support the strip terminal; and
a roller configured to bend the bending portion of the strip terminal by pushing the strip terminal supported by the support jig, resulting in a bent strip terminal.

17. The apparatus as claimed in claim 16, wherein the support jig of the bending jig pushes the bent strip terminal toward the electrode assembly to bend the electrode tabs.

18. The apparatus as claimed in claim 16, wherein the support jig of the bending jig comprises a support surface of 90° or less so that the roller presses the strip terminal to form the bending portion at a bending angle of 90° or less.

19. The apparatus as claimed in claim 16, wherein the bending jig further comprises a front guide configured to support the electrode tabs in a direction opposite to a direction in which the support jig supports the strip terminal.

20. The apparatus as claimed in claim 19, wherein the front guide is further configured to move away from the strip terminal when the support jig bends the electrode tabs.
